(19) United States
(12) Patent Application Publication
(10) Pub. No.: US 2026/0298827 A1
(43) Pub. Date: Oct. 1, 2026

(54) METHOD AND APPARATUS FOR DYNAMIC MULTI PLANE FLUORESCENCE MICROSCOPY

(71) Applicant: Fluorescence Microscopy Business Unit (FMBU) of Bruker Nano Surfaces Division, Madison, WI (US)

(72) Inventors: Michael Dombrowski, Madison, WI (US); Selcuk Akturk, Madison, WI (US); Jimmy Fong, Madison, WI (US)

(73) Assignee: Fluorescence Microscopy Business Unit (FMBU) of Bruker Nano Surfaces Division, Madison, WI (US)

(21) Appl. No.: 19/475,956

(22) PCT Filed: Apr. 26, 2024
(86) PCT No.: PCT/US2024/026491

§ 371 Date: Oct. 16, 2025

Related U.S. Application Data
(60) Provisional application No. 63/498,959, filed on Apr. 28, 2023.

(51) Int. Cl. G01N 21/64; G02B 5/00; G02B 21/00; G02B 26/08

(52) U.S. Cl. CPC G01N 21/6458; G02B 5/001; G02B 21/0076; G02B 26/0841

(57) ABSTRACT

Disclosed herein is an apparatus and method for dynamic multi plane imaging or photo-stimulation. The apparatus and method make use of the ON-state and OFF-state pixels of a digital micromirror device (DMD) in tandem to form an ON-direction beam and an OFF-direction beam. Ring-shaped mask patterns are imposed along the ON-direction and go through a Bessel-beam forming step. The OFF-direction beam goes through time-delay control and divergence/convergence control independently from the ON-direction beam. The ON- and OFF-direction beams form multiple excitation planes with dynamically controllable locations inside a sample.

### CROSS-REFERENCE TO RELATED APPLICATIONS

Priority is hereby claimed to U.S. provisional application Ser. No. 63/498,959, filed Apr. 28, 2023, which is incorporated herein by reference.

### BACKGROUND

Modem implementations of fluorescence microscopy allow investigations into biological structures at increasingly better spatial and temporal resolutions. Many biochemical interactions take place at time scales of small fractions of a second and capturing those dynamics requires imaging methods with similar or better update rates. Additionally, cells in live tissues also frequently interact with both adjacent cells and distant cells via a myriad of signaling mechanisms. It is often desired to capture measurement data from two physically separated regions, at the same point in time. In neuroscience, for example, understanding the interaction between neurons from different layers of the cortex is crucial in deciphering the functionality of neuronal networks.

Scanning laser microscopy is one of the main workhorses for in vivo investigation of brain tissues. Confocal microscopy and multi-photon microscopy are very commonly used because both methods allow imaging not only superficial but also in-volume regions, with multi-photon imaging providing more than millimeter penetration depth in brain tissues. Both methods are based on point-scan, where a laser beam is tightly focused through a microscope objective and raster-scanned over the region-of-interest, as wide as allowed by the optical and mechanical constraints of the device used.

In scanning laser microscopy, the depth of the imaging plane can be determined via optical or mechanical means. Moving the sample or the microscope objective along the direction of light (the “z-direction”) changes the focal plane inside the sample. Piezo-based motion systems allow high-resolution translation, with speeds limited to tens of milliseconds for switching times between planes. Optical methods typically control the convergence or divergence of the incoming laser beam to shift the focal plane. Elements such as deformable mirrors or electrically tunable lenses are commonly used for this purpose.

Digital Micromirror Devices (DMDs) are pixelated devices, consisting of a large number of micro-mirrors. Each micro-mirror is individually addressed and can be tilted in two discrete directions, referred to as ON and OFF states When illuminated with a coherent laser beam, a DMD behaves like a diffraction grating, which directs the outgoing light into discrete directions called “orders”, determined by the constructive interference conditions. Conventional applications of DMDs treat the ON state and its corresponding outgoing light direction as the main output and dump the OFF-direction light.

In the present disclosure, the ON and OFF states of DMDs are used in tandem for dynamic, multi-plane microscopy. The apparatus and method allow simultaneous microscopic imaging from discrete regions of a specimen, allowing dynamic, time-resolved imaging of biochemical events occurring therein. The apparatus and method are of substantial value in various domains of life sciences.

### SUMMARY

Disclosed herein is an apparatus and method for dynamic multi-plane imaging or photo-stimulation, using the ON- and OFF-state pixels of a digital micromirror device (DMD) in tandem to create multiple focal planes in a sample, simultaneously.

Specifically, disclosed herein is an apparatus for dynamic multi-plane imaging or photo-stimulation, comprising:
a laser source dimensioned and configured to generate an input laser beam;
a digital micromirror device (DMD) dimensioned and configured to receive the input laser beam: wherein:
   the DMD comprises a plurality of micromirrors, and each of the plurality of micromirrors can be switched individually between an ON and an OFF state;
   the micromirrors in the ON state reflect a portion of the input laser beam to an ON direction to form an ON-direction beam; and
   the micromirrors in the OFF state reflect the remainder of the input laser beam to an OFF direction to form an OFF-direction beam; and
a scanning microscope dimensioned and configured to transfer the ON-direction beam and the OFF-direction beam to different focal planes of a sample.

The DMD is dimensioned and configured to mask a desired pattern over the input laser beam and to propagate the masked pattern along the ON direction. Preferably, the masked pattern is a ring-shaped pattern.

The apparatus further comprises a beam-shaping element dimensioned and configured to convert the ON-direction beam to a beam with controlled position and length-of-line focus, wherein the beam resulting from the beam-shaping element is a Bessel beam. The beam-shaping element may be an axicon, a spatial light modulator, or a diffractive axicon.

The apparatus further comprises an optical detector to collect fluorescent signals from the sample illuminated with the ON- and OFF-direction beams to form an overlaid image. Alternatively, the apparatus further comprises a time-delay control element to delay the signal of the OFF-direction beam, and a time-resolved signal detector to collect signals separately from the sample illuminated with the ON- and OFF-direction beams to obtain individual images of the focal planes of the ON- and OFF-direction beams.

The apparatus further comprises a divergence/convergence control element to control the OFF-direction beam independently from the ON-direction beam. The divergence/convergence control element may be a deformable mirror or an electrically tunable lens.

Preferably, the apparatus further comprises an astigmatism controller dimensioned and configured to correct for beam ellipticity, which is placed before the DMD or after the DMD, and along one or both of the ON and OFF directions.

Preferably, the apparatus further comprises a diffractive element dimensioned and configured to correct for angular dispersion, which is placed before the DMD or after the DMD, and along one or both of the ON and OFF directions.

The apparatus further comprises a beam combiner dimensioned and configured to spatially combine the ON- and the OFF-direction beams transferred to the scanning microscope. Preferably, the beam combiner is a polarizing beam combiner. After beam combining, the apparatus further comprises a beam steerer dimensioned and configured to offset in angle the ON- and the OFF-direction beams, yielding image plane shifts in the transverse plane.

Also disclosed herein is a method for dynamic multi-plane imaging or photo-stimulation using the apparatus. The method comprises:
(a) generating an input laser beam;
(b) receiving the input laser beam by a digital micromirror device (DMD) comprising a plurality of micromirrors that can be switched individually between an ON and an OFF state, forming an ON-direction beam by reflecting a portion of the input laser beam to an ON direction by the micromirrors in the ON state, and forming an OFF-direction beam by reflecting the remainder of the input laser beam to an OFF direction by the micromirrors in the OFF state; and
(c) transferring the ON-direction beam and the OFF-direction beam to different focal planes of a sample.

The method further comprises masking a desired pattern over the input laser beam and propagating the masked pattern along the ON direction. Preferably, the masked pattern is a ring-shaped pattern.

The method further comprises converting the ON-direction beam to a beam with controlled position and length-of-line focus, wherein the beam with controlled position and length-of-line focus is a Bessel beam.

The method further comprises collecting fluorescent signals from the sample illuminated with the ON- and OFF-direction beams to form an overlaid image. Alternatively, the method further comprises delaying signal of the OFF-direction beam, and collecting signals separately from the sample illuminated with the ON- and OFF-direction beams to obtain individual images of the focal planes of the ON- and OFF-direction beams.

The method further comprises controlling divergence/convergence of the OFF-direction beam independently from the ON-direction beam.

Preferably, the method further comprises correcting for beam ellipticity before step (b) or after step (b), and along one or both of the ON and OFF directions. That is, before or after receiving the input laser beam by the DMD.

Preferably, the method further comprises correcting for angular dispersion before step (b) or after step (b), and along one or both of the ON and OFF directions.

Step (c) of the method further comprises spatially combining the ON- and the OFF-direction beams transferred to the sample. Preferably, the ON- and the OFF-direction beams are spatially combined using a polarization-based combination. After combining, the method further comprises offsetting in angle the ON- and OFF-direction beams, yielding image plane shifts in the transverse plane.

The objects and advantages of the disclosure will appear more fully from the following detailed description of the preferred embodiment of the disclosure made in conjunction with the accompanying drawings.

### BRIEF DESCRIPTION OF THE DRAWINGS

FIG. 1. shows a schematic of dynamic multi-plane imaging using DMD-based scanning laser microscopy.

FIG. 2 shows conversion of a Gaussian beam to a Bessel beam by an axicon.

FIG. 3 shows the radial and axial intensity distribution of a Bessel beam, calculated according to Eq. 4.

FIG. 4 is a geometrical illustration of controlling the position and length of the line focus of a Bessel beam.

FIG. 5 shows the optical behavior of a DMD as a diffraction grating with angled facets.

FIG. 6 shows examples of ring-type patterns calculated and projected onto the DMD.

FIG. 7 shows input-output angle configurations for a particular DMD.

FIG. 8 shows the z-direction and the xv-plane (transverse plane) of a sample. The DMD-based device disclosed herein allows rapid switching between imaging planes along the z-direction. The ON- and OFF-direction beams can also be offset in angle after beam combining. yielding imaging plane shifts in the transverse plane.

### DETAILED DESCRIPTION

The following is a detailed description of the disclosure provided to aid those skilled in the art in practicing the present disclosure. Those of ordinary skill in the art may make modifications and variations in the embodiments described herein without departing from the spirit or scope of the present disclosure.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

As used herein, the singular forms “a,” “an,” and “the” include plural referents unless the content clearly dictates otherwise.

As used herein, the term “or” is an inclusive “or” operator and is equivalent to the term “and/or” unless the context clearly dictates otherwise.

The elements and method steps described herein can be used in any combination whether explicitly described or not, unless otherwise specified or clearly implied to the contrary by the context in which the referenced combination is made.

All combinations of method steps as used herein can be performed in any order, unless otherwise specified or clearly implied to the contrary by the context in which the referenced combination is made.

The apparatus and method disclosed herein may comprise, consist of, or consist essentially of the various steps and elements disclosed herein. The disclosure provided herein may be practiced in the absence of any element or step which is not specifically disclosed and required herein.

It is understood that the disclosure is not confined to the specific elements and method steps herein illustrated and described, but embraces such modified forms thereof as come within the scope of the claims.

### Schematic of the Apparatus and Method:

The apparatus and method disclosed herein are based on a z-device for changing the imaging plane of a microscope using a digital micromirror device (DMD). The DMD-based z-device combines the elongated focus of Bessel beams with the rapid beam-shaping capability of DMDs. This yields a z-device (and corresponding method) that surpasses speeds of other optical or mechanical alternatives, reaching switching times at scales of microseconds. The DMD-based z-device allows rapid switching between imaging planes, independent of their relative depth.

Disclosed herein is an apparatus and method where the ON and OFF states of a DMD are used in tandem for dynamic, multi-plane microscopy. The DMD-based z-device works by imposing ring-like patterns on the incoming laser beam. Changing the inner/outer radii of these rings moves the effective sample plane along the z-direction. In the present disclosure, the portion of the beam that does not fall within the ring is collected and re-directed to the sample, to form an additional imaging plane. The ON and OFF directions are both used and focused at different planes on the sample, allowing dynamic imaging (simultaneous or time-resolved) from discrete regions. This capability unlocks heretofore unachievable possibilities in biomedical imaging domains. For instance, in vivo functional imaging in neuroscience is continuously shifting towards investigation of faster dynamics (such as voltage changes across neurons, a recent capability made possible by the onset of corresponding voltage-sensitive fluorescent dyes). These experiments often require high-speed recordings from multiple locations to elucidate neuronal communications and networks.

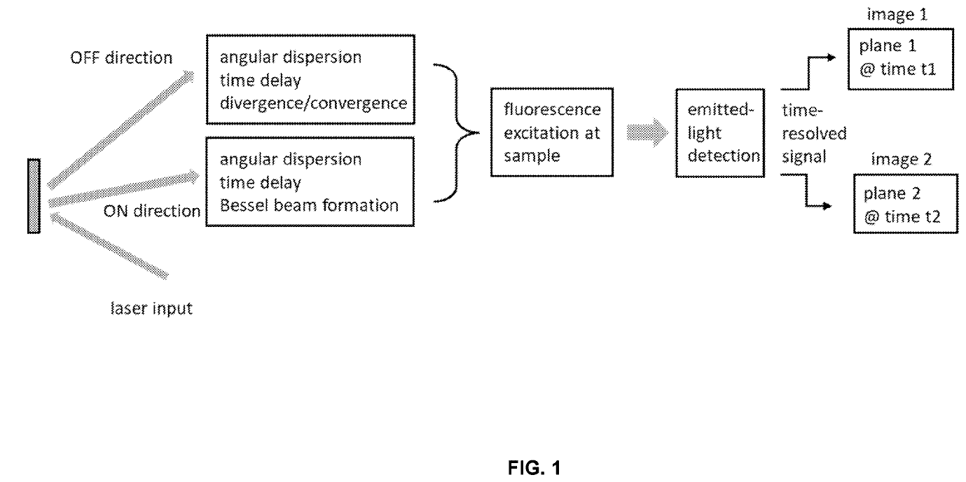

A schematic of the optical arrangement of the apparatus and method disclosed herein is shown in FIG. 1. A laser beam is first directed to a computer-controlled DMD. The laser can be, for example (and non-limiting) a femtosecond-pulsed near-infrared laser for multi-photon fluorescence microscopy. The angular orientation of the DMD can be configured such that the diffraction efficiency is optimal at a given direction when the micro-mirrors are set to the ON state (the “ON direction”). In a preferred version, a ring-shaped mask pattern is applied to the DMD, which results in a ring-shaped beam propagating along the ON direction. All other micro-mirrors on the DMD's array are in the OFF state and they direct the remainder of the laser beam in a direction different from the ON direction. This direction, the “OFF direction,” is determined by angle of incidence, micro-mirror tilt angle, and the diffraction of light. The two discrete beams thereby formed subsequently go through separate spatial and temporal conditioning steps. Broadband laser sources such as femtosecond lasers tend to disperse out into a narrow fan of angles (known as “angular dispersion”). It is desirable to compensate this effect, which can be done using optical elements such as prisms and diffraction gratings. Preferably, angular dispersion compensation is performed on both ON and OFF direction beams. The ON direction beam goes through a Bessel-beam forming step, which can consist of an axicon lens and a relay system. If the laser source is pulsed, the relative timing of the pulses in the ON and OFF directions can be controlled by additional free-space propagation or insertion of a medium with desired thickness in the beam path of the ON or OFF direction. The OFF-state beam preferably goes through angular dispersion compensation and time-delay control. The OFF arm can also include additional divergence/convergence control elements such as deformable mirrors, electrically tunable lens, and the like.

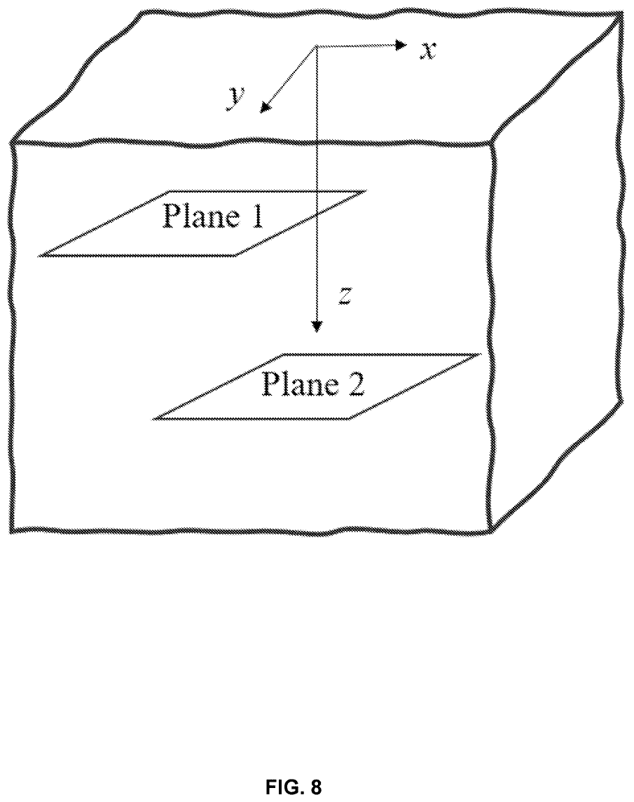

After independent spatial and temporal conditioning, the ON and OFF arms are directed to the main body of the fluorescence microscope, spatially combined, and focused onto the sample. The combining step can involve polarizing or non-polarizing beam combiners. Polarization-based combination is preferred way for power efficiency, and it involves controlling the polarization state of the ON and OFF arms via optical wave-plates. The ON direction imaging plane's z-position can be rapidly and dynamically controlled via projecting corresponding ring-patterns on the DMD. The OFF-direction plane can be static, or independently controlled using the aforementioned divergence-convergence mechanisms. The two beams can also be offset in angle after beam combining, yielding imaging plane shifts in the transverse plane (i.e., the xy-plane as shown in FIG. 8). These two beams thereby form multiple excitation planes (along the z-direction and/or across the xy-plane) with dynamically controllable locations inside the sample under study.

The light emitted from fluorescent molecules within the sample is subsequently collected and directed to an optical detector to generate the image of the interrogated regions. Fluorescent signals generated by the two beams can be collected together to form an overlaid image. Alternatively, using the time delay introduced between the ON and OFF direction beams and using a time-resolved signal detector, individual images of the two planes can be reconstructed.

The beams throughout the ON and OFF states and beam conditioning steps therein can be interchanged (ON for OFF and vice-versa).

Multi-photon imaging systems are often furnished with a secondary laser source used for manipulating cells with light, a method known as photo-stimulation. The beams through the ON and OFF states can also be used for photo-stimulation.

### Bessel Beams:

The fundamental optical concept behind volumetric imaging is generating line-foci, which are achieved via so-called non-diffracting beams or Bessel beams. Laser cavities generally emit transverse intensity profiles described in terms of Gaussian beams (A.E. Siegman, “Lasers,” © 1986 University Science Books, Melville, NY; ISBN 9780935702118. In the most commonly used case, also known as single-mode or TEM₀₀, the intensity cross section follows a bell-shape curve, while the width of the bell varies by propagation:

$$I ( r , z ) = \frac{P}{π {w ( z )}^{2}} exp ( - 2 \frac{{r}^{2}}{{w ( z )}^{2}} ) \qquad Eq . 1$$

where I is optical intensity or irradiance, defined by energy per unit area per unit time, r is radial position, z is axial position, w(z) is the beam radius, and P is the total power of the beam. It is important to note the dependence of the beam radius on z, the propagation distance. This dependence is given by:

$$w ( z ) = {w}_{0} \sqrt{1 + {( z / {z}_{R} )}^{2}} \qquad Eq . 2$$

$$wherein$$

$${z}_{R} = π {w}_{0}^{2} / λ \qquad Eq . 3$$

λ being the wavelength of the input laser light. In Eqs. 2-3 above, w₀ is the minimum radius for a given Gaussian beam and often referred to as beam waist; and z_{R} is the propagation distance over which intensity falls by one-half.

The propagation behavior described above is a direct consequence of the wave nature of light, or more particularly, diffraction. It is fundamentally dictated that the smallest radius of a focused beam is approximately half the wavelength. In the light of Eq. 3, the axial extent of such a focused beam would be of the order of the wavelength, as well. This lower-bound is known as the diffraction limit. A focused Gaussian beam has an ellipsoid-like three-dimensional shape. This strong localization can be an advantage for point-scanning, as it increases axial and lateral resolution. However, it also hinders volumetric scanning, or other applications where longer focal regions would be preferable.

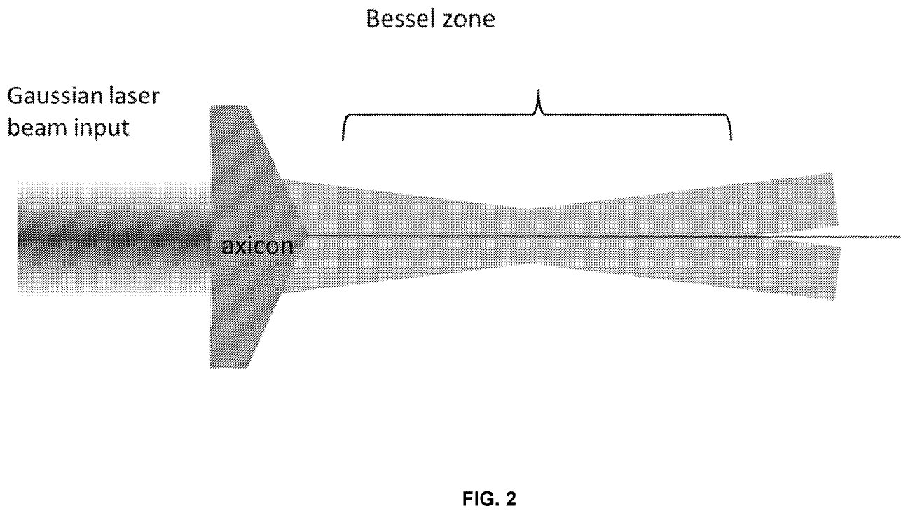

The mathematical basis of non-diffracting beams was first laid out by Durnin (J. Dumm et al. (1987) “Diffraction-free beams,” Phys Rev Lett, 58(15):1499-150, who show that if the radial profile of light follows a Bessel-function of the first kind, the beam radius and intensity becomes independent of the propagation distance. While this mathematical idealization for Bessel beams requires infinite energy, and hence is not practical, approximations are possible. One of the easiest and most commonly used ways of converting a Gaussian beam to a Bessel beam is using a conical lens or an axicon. J. H. McLeod, (1954) “The Axicon: A new type of optical element,” J Opt Soc Am, 44(8):592-597. As shown in FIG. 2, when a Gaussian beam passes through an axicon, it splits into a cone of angular spread and over the region where the beam remains overlapped, the Bessel zone is formed.

The intensity profile of Bessel beams generated by an axicon is given by J. Arlt and K. Dholakia (2000) “Generation of high-order Bessel beams by use of an axicon,” Opt Commun, 177(1-6):297-301:

$$I ( r , z ) = \frac{4 Pkr sin β}{{w}_{0}} \frac{z}{{z}_{max}} {J}_{0}^{2} ( kr sin β ) exp ( - 2 \frac{{z}^{2}}{{z}_{max}^{2}} ) \qquad Eq . 4$$

where k is the wavenumber given by 2π/λ, β is the half-cone angle of the beam after axicon, w₀ is the radius of the incoming Gaussian beam, zₘₐₓ is the axial position where maximum intensity occurs, and Jo is the zeroth-order Bessel function of the first kind.

Other methods for generating Bessel beams include, but are not limited to, using a narrow ring followed by a lens (J. Durnin et al. (1987) “Diffraction-free beams.” Phys Rev Lett, 58(15):1499-1501, spatial light modulators (R. Bowman et al. (2011) “Efficient generation of Bessel beam arrays by means of an SLM,” Eur. Phys. J Spec. Top., 199(1):159-166), and circular periodic gratings (L. Niggl et al. (1997) “Properties of Bessel beams generated by periodic gratings of circular symmetry,” J Opt Soc Am A, 14(1): 27-33. Regardless of the method of generation, these beams share common propagation characteristics, as summarized below.

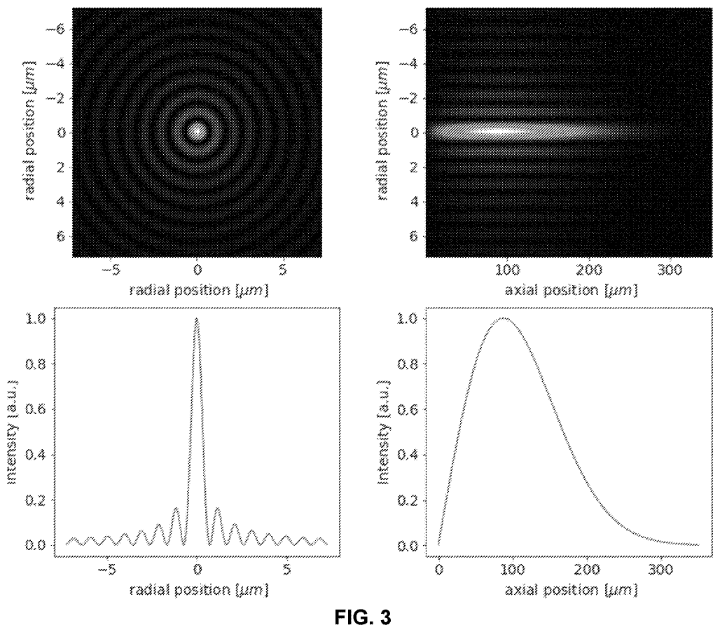

Typical intensity profiles of Bessel beams are shown in FIG. 3. There is a central spot where the intensity is highest, surrounded by concentric rings with gradually decreasing intensity. In the axial direction, the beam exhibits a line-like shape. Most notably, the beam radius (width of the central peak) is independent of propagation distance within the Bessel zone, in acute contrast to Gaussian beams.

Volumetric imaging using Bessel beams has been exploited in previous inventions. For example, Theriault et al. uses axicon-generated Bessel beams in a multiphoton microscope to collect extended-depth-of-field volumetric images. See U.S. Pat. No. 9,201,008. In a more recent invention, Bessel-beams are generated via a spatial-light modulator (SLM), which mimics the optical phase induced by an axicon. See U.S. Pat. No. 10,809,510.

### DMD for Beam Shaping and Masking:

Beam shaping and masking allows fine control over the length of the line focus of Bessel beams. The method is based on masking selected regions of a laser beam incident on an axicon, or other Bessel beam-forming optical system. Following the geometry of FIG. 2, one can see that the Bessel zone (the region over which line focus sustains) is determined not only by the cone angle, but also by the input beam size. By masking out annular zones of the input beam, the Bessel zone can be restrained from both directions in the z-axis.

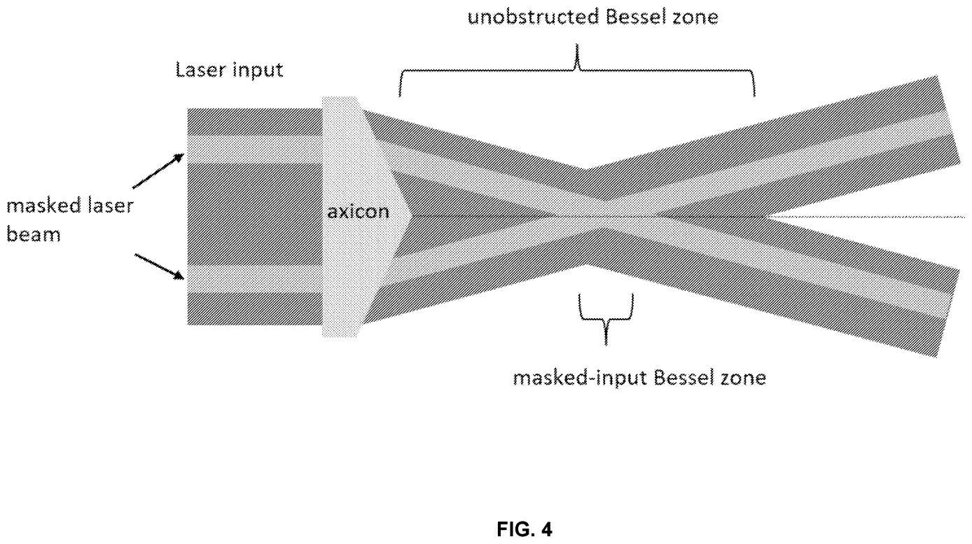

The optical background of the method is illustrated in FIG. 4. The figure shows a typical Gaussian laser beam (dark regions) coming from the left and going through the axicon. The region over which the cone of beams overlap is the line focus or the Bessel beam zone. The figure also shows (lighter regions) a masked beam, which in turn generates a shorter overlap region. The length and position of the focal zone is determined by the inner/outer radii of the mask. As a result, by using pertinent input masks, one can generate line foci at controllable depths and with controllable lengths.

Rapid and programmatic control of the Bessel zone shown in FIG. 4 requires a computerized way of generating input masks. A DMD can be used for this purpose. DMDs are described in U.S. Pat. No. 9,348,136 and thus will not be described in great detail herein. Suffice to say a DMD is an optical-electronic device made of an array of micrometer-size mirrors. Each mirror operates in binary mode (ON and OFF angles). The array is illuminated by a light source, and the reflected light pattern is processed by projecting desired binary patterns to the micro-mirror arrays. Due to the miniature nature of individual elements, DMDs can be operated at 32 kHz pattern rates and beyond.

Beam shaping and masking using DMDs allows fine control over the length of the line focus of Bessel beams, in a very rapid manner, at speeds as fast as 32 kHz or greater. Furthermore, by choosing a sufficiently narrow axial region, one can obtain radial and axial resolution approaching that of conventional Gaussian beam imaging, and in addition allowing depth scans with rates as fast as 32 kHz or greater. Some advantages are that it allows volumetric imaging to work on several times denser samples; it brings about the ability to select planes to be imaged in rapid manner; and it provides means to shift the focal region in z-direction much faster than the x-y axes, significantly reducing the overall image acquisition time.

DMDs have been used in recent multiphoton imaging applications. Geng et al. used a DMD device to generate binary holograms and to project corresponding laser beams to samples to create a rapidly-adjustable random-access multiphoton imaging apparatus (Q. Geng et al. (2017) “Digital micromirror device-based two-photon microscopy for three-dimensional and random-access imaging,” Optica, 4(6):674-677. Ducros et al. used a spatial light modulator (“SLM”) to create a multitude of beam patterns and a DMD to project a desired one of these patterns on the sample to be imaged (M. Ducros et al. (2013) “Encoded multisite two-photon microscopy,” Proc. Nal. Acad. Sci., 110(32):13138-13143. The DMD allowed rapid alteration between desired input beam conditions and correspondingly rapid jumps to various regions inside the sample under investigation. Park et al. exploited the angular dispersion introduced by DMD to enhance axial resolution in two-photon imaging (J. K. Park et al. (2017) “Enhanced Axial Resolution of Wide-Field Two-Photon Excitation Microscopy by Line Scanning Using a Digital Micromirror Device,” Micromachines, 8(3): Art. No. 3.

For using DMDs in laser or other coherent source applications, particular considerations must be addressed. Due to their periodic pixelated nature, DMDs optically behave as diffraction gratings. When monochromatic light is incident on a diffraction grating with periodic grooves of separation d, part of the light is specularly reflected (angle of incidence being equal to angle of reflection), while part is diffracted in one or more directions. The angle of the diffracted beam is given by grating equation:

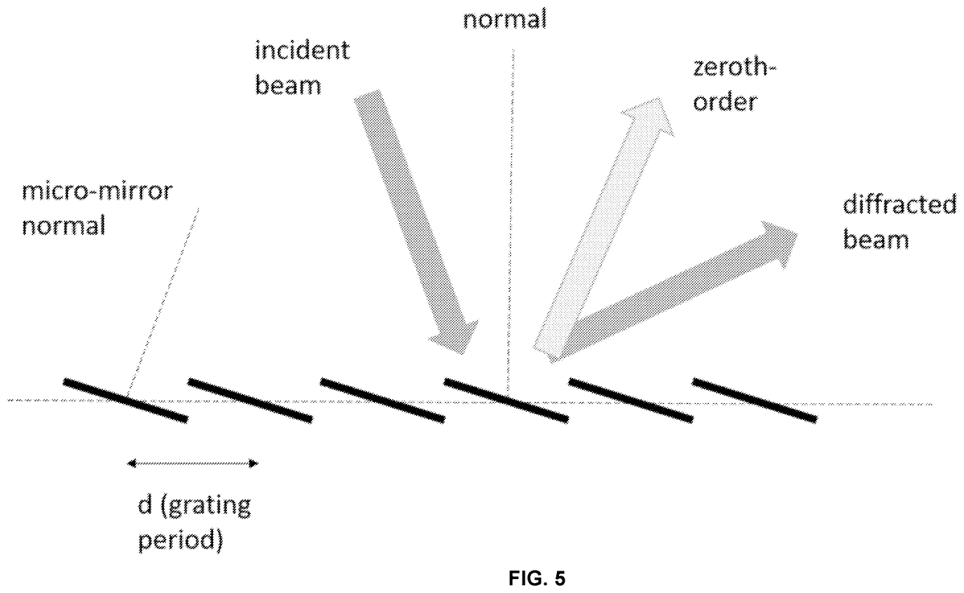

d(sin θᵢₙ+sin θₘ)=mλ Eq. 5

where θᵢₙ is the angle the input beam makes with the surface normal, θₘ is the angle of diffracted beam for a particular diffraction order, and m is a positive or negative integer called diffraction order. In general, the presence of numerous diffraction orders reduces the total light power in a particular order. This hurdle is mitigated by using blazed gratings, which consist of sawtooth-like facet profiles (FIG. 5). If the angle of each facet and angle of incidence is arranged such that specular reflection off a facet coincides with a diffraction order, a large proportion of the incident power concentrates in that order. A blazed grating configuration is directly applicable to DMDs (FIG. 5). For highest performance regarding optical throughput, the DMD is configured so that specular reflection off the micro-mirror normal is made coincident with a diffraction order.

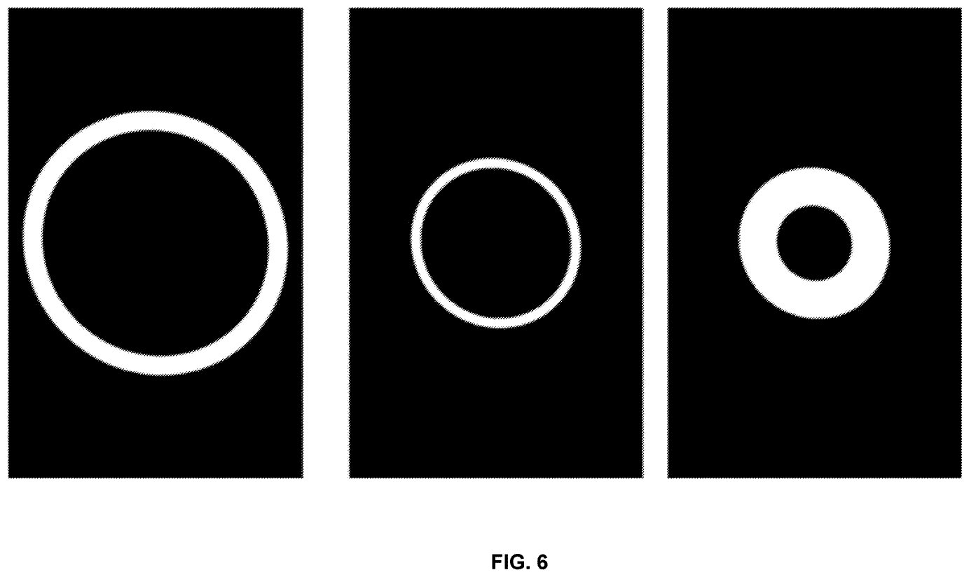

The DMD may be controlled by Field-Programmable Gate Array (FPGA)-based high-speed electronics. Desired patterns are pre-calculated and loaded onto the controller through a personal computer. The patterns are images consisting of black-and-white regions, which the DMD controller interprets as OFF and ON states for corresponding pixels (e.g., micromirrors). FIG. 6 shows some examples of ring-type patterns calculated and used in practical uses of the apparatus. The DMD can be used to generate a mask with multiple simultaneous rings, such that each ring generates a different focal zone in the sample plane, allowing simultaneous imaging from a plurality of planes. Alternatively. The DMD can switch between two ring shapes, such that each ring generates a different focal zone in the sample plane, allowing interlaced imaging between the two planes.

The DMD can be in close proximity to the Bessel-beam-forming element, in order to minimize diffractive spread due to the imposed mask. Alternatively, an optical relay can create the image of the DMD surface at the entrance facet of the Bessel-beam-forming element. In one configuration, a 4f-relay system is used, where two identical lenses of each with focal distance f is used, the first lens is a distance f away from DMD, lens separation is 2f and beam propagates another distance f until the relay plane.

Bessel beam-forming elements can be chosen among different alternatives. One method is to use a conical lens (also known as axicon). In one configuration, a conical lens of base angle 2 degrees is employed. One can also use a spatial light modulator, which is a pixelated element that can generate desired optical phase patterns via computer control. Another alternative is using a periodic diffraction grating of circular symmetry, or diffractive axicons. In all these configurations, the dimensions of the ring-like profile projected on the DMD will determine the depth of the Bessel zone formed after the element. In another alternative configuration, the ring is made sufficiently narrow as to induce large beam spread due to diffraction, the relay plane of the ring is followed by a conventional lens, and a Bessel beam is formed at and around the focal plane of the lens (J. Durnin et al., “Diffraction-free beams,” Phys Rev Lett, vol. 58, no. 15, pp. 1499-1501, 1987).

### Compensation for Angular Dispersion:

Multiphoton imaging systems employ pulsed lasers with typically femtosecond and picosecond (also known as ultrashort) pulse durations. These laser sources require another level of attention when DMDs are to be employed. Ultrashort pulses are inherently broadband, containing a range of wavelengths. According to the grating equation (Eq. 5), diffraction angle is different for each wavelength, and hence, reflection off a DMD causes ultrashort pulses to spread into a fan of angles. This phenomenon is called angular dispersion (S. Akturk et al. (2005) “The general theory of first-order spatio-temporal distortions of Gaussian pulses and beams,” Opt Express, 13(21):8642-8661), and is often undesirable since it causes beam ellipticity, increases pulse duration, and consequently decreases fluorescence signal in imaging applications. Angular dispersion can be corrected before or after the DMD in multitude of ways, including using another diffraction grating of appropriate periodicity, a prism of appropriate material and angle, and using combination of gratings, prisms and lenses (J. Cheng et al. (2015) “High-speed femtosecond laser beam shaping based on binary holography using a digital micromirror device,” Opt. Lett., 40(21):4875-4878.)

A diffraction grating may be used to pre-compensate angular dispersion imposed by the DMD. The diffraction grating used for angular-dispersion correction can be a reflective or transmissive one. The groove density of the diffraction grating can be designed such that angular dispersion of the masking device and diffraction grating are equal in magnitude but opposite in sign. In one example, a diffraction grating with 600 mm⁻¹ groove density is used. This spacing substantially negates the angular dispersion of the DMD. The diffraction grating is kept in close physical proximity to the DMD to avoid substantial separation of colors (also known as spatial dispersion) due to the angular spread of wavelengths. Alternatively, one can use a diffraction grating followed by a pair of lenses to obtain extended separation between the diffraction grating and DMD, as well as obtaining no spatial dispersion. As another alternative, one can use combination of prisms and gratings of determined parameters to substantially or totally negate angular and spatial dispersion after DMD. In another example, a customized transmissive volume-phase-holographic diffraction grating with desired grove density is used to substantially negate the angular dispersion of the DMD, for high transmission efficiency.

### Compensation for Beam Ellipticity:

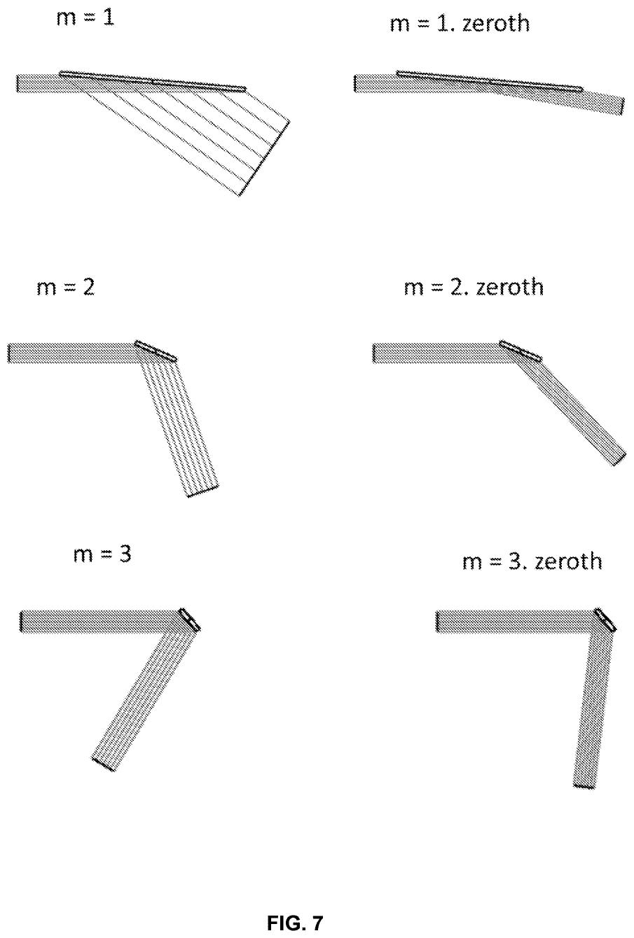

Diffraction gratings and hence also DMDs introduce beam ellipticity even for a monochromatic laser beam. When the grating equation (Eq. 5) is applied to an extended beam, it can be observed that in the plane of diffraction, the beam extends for incident and diffracted beams can differ, unlike the specular reflection case (zeroth order). If desired, beam ellipticity can be corrected by using astigmatism-control elements such as elliptical lenses, auxiliary gratings, or prisms. The ellipticity can also be controlled by adjusting the projected micro-mirror ON-OFF pattern on the overall DMD surface (FIG. 7).

In some embodiments, the laser output beam is conditioned using pairs of spherical and cylindrical lenses. Spherical lenses make up a circularly symmetric beam expander/compressor, to fill-up a desired portion of the DMD. The cylindrical lenses make up an elliptical beam expander/compressor to compensate for the ellipticity resulting from the downstream diffractive elements to follow. The placement of these beam-conditioning elements can be before or after the DMD. Astigmatism compensation is not mandatory for the method and apparatus described herein. It is, however, desired. Correction before the DMD enhances power throughput.

1. An apparatus for dynamic multi-plane imaging or photo-stimulation, comprising:
a laser source dimensioned and configured to generate an input laser beam;
a digital micromirror device (DMD) dimensioned and configured to receive the input laser beam; wherein:
the DMD comprises a plurality of micromirrors, and each of the plurality of micromirrors can be switched individually between an ON and an OFF state;
the micromirrors in the ON state reflect a portion of the input laser beam to an ON direction to form an ON-direction beam; and
the micromirrors in the OFF state reflect the remainder of the input laser beam to an OFF direction to form an OFF-direction beam; and
a scanning microscope dimensioned and configured to transfer the ON-direction beam and the OFF-direction beam to different focal planes of a sample.

2. The apparatus of claim 1, wherein the DMD is dimensioned and configured to mask a desired pattern over the input laser beam and to propagate the masked pattern along the ON direction.

3. The apparatus of claim 2, wherein the masked pattern is a ring-shaped pattern.

4. The apparatus of claim 1, further comprising a beam-shaping element dimensioned and configured to convert the ON-direction beam to a beam with controlled position and length-of-line focus.

5. The apparatus of claim 4, wherein the beam formed by the beam-shaping element is a Bessel beam.

6. The apparatus of claim 4, wherein the beam-shaping element is an axicon, a spatial light modulator, or a diffractive axicon.

7. The apparatus of claim 1, further comprising an optical detector to collect fluorescent signals from the sample illuminated with the ON- and the OFF-direction beams to form an overlaid image.

8. The apparatus of claim 1, further comprising a time-delay control element to delay signal from the OFF-direction beam.

9. The apparatus of claim 8, further comprising a time-resolved signal detector to collect signals separately from the sample illuminated with the ON- and the OFF-direction beams to obtain individual images of the focal planes of the ON- and the OFF-direction beams.

10. The apparatus of claim 1, further comprising a divergence/convergence control element to control the OFF-direction beam independently from the ON-direction beam.

11. The apparatus of claim 10, wherein the divergence/convergence control element is a deformable mirror or an electrically tunable lens.

12. The apparatus of claim 1, further comprising an astigmatism controller dimensioned and configured to correct for beam ellipticity, which is placed before the DMD or after the DMD, and along one or both of the ON and the OFF directions.

13. The apparatus of claim 1, further comprising a diffractive element dimensioned and configured to correct for angular dispersion, which is placed before the DMD or after the DMD, and along one or both of the ON and the OFF directions.

14. The apparatus of claim 1, further comprising a beam combiner dimensioned and configured to spatially combine the ON- and the OFF-direction beams transferred to the scanning microscope.

15. The apparatus of claim 14, wherein the beam combiner is a polarizing beam combiner.

16. The apparatus of claim 14, further comprising a beam steerer dimensioned and configured to offset in angle the ON- and the OFF-direction beams after beam combining, yielding image plane shifts in the transverse plane.

17. A method for dynamic multi-plane imaging or photo-stimulation, comprising:
(a) generating an input laser beam;
(b) receiving the input laser beam by a digital micromirror device (DMD) comprising a plurality of micromirrors that can be switched individually between an ON and an OFF state, forming an ON-direction beam by reflecting a portion of the input laser beam to an ON direction by the micromirrors in the ON state, and forming an OFF-direction beam by reflecting the remainder of the input laser beam to an OFF direction by the micromirrors in the OFF state; and
(c) transferring the ON-direction beam and the OFF-direction beam to different focal planes of a sample.

18. The method of claim 17, further comprising masking a desired pattern over the input laser beam to yield a masked pattern and propagating the masked pattern along the ON direction.

19. The method of claim 18, wherein the masked pattern is a ring-shaped pattern.

20. The method of claim 17, further comprising converting the ON-direction beam to a beam with controlled position and length-of-line focus.

21. The method of claim 20, wherein the beam with controlled position and length-of-line focus is a Bessel beam.

22. The method of claim 17, further comprising collecting fluorescent signals from the sample illuminated with the ON- and the OFF-direction beams to form an overlaid image.

23. The method of claim 17, further comprising delaying signal of the OFF-direction beam.

24. The method of claim 23, further comprising collecting signals separately from the sample illuminated with the ON- and the OFF-direction beams to obtain individual images of the focal planes of the ON- and the OFF-direction beams.

25. The method of claim 17, further comprising controlling divergence/convergence of the OFF-direction beam independently from the ON-direction beam.

26. The method of claim 17, further comprising correcting for beam ellipticity before step (b) or after step (b), and along one or both of the ON and the OFF directions.

27. The method of claim 17, further comprising correcting for angular dispersion before step (b) or after step (b), and along one or both of the ON and the OFF directions.

28. The method of claim 17, wherein step (c) further comprises spatially combining the ON- and the OFF-direction beams transferred to the sample.

29. The method of claim 28, wherein the ON- and the OFF-direction beams are spatially combined using a polarization-based combination.

30. The method of claim 28, further comprising offsetting in angle the ON- and OFF-direction beams after combining, yielding image plane shifts in the transverse plane.
